(19) United States
(12) Patent Application Publication
(10) Pub. No.: US 2018/0276549 A1
(43) Pub. Date: Sep. 27, 2018

(54) SYSTEM FOR REAL-TIME PREDICTION OF REPUTATIONAL IMPACT OF DIGITAL PUBLICATION

(71) Applicant: INTERNATIONAL BUSINESS MACHINES CORPORATION, ARMONK, NY (US)

(72) Inventors: HOANG TAM VO, MELBOURNE (AU); ZIYUAN WANG, MALVERN EAST (AU)

(21) Appl. No.: 15/470,527

(22) Filed: Mar. 27, 2017

(51) Int. Cl. G06N 5/04

(52) U.S. Cl. CPC G06N 5/043

(57) ABSTRACT

A method for reviewing digital publications includes receiving a digital publication while it is being composed. Potential audiences are identified for the digital publication. Information is received from feeds and social media content. A context is modeled for each potential audience based on the received information. The digital publication is analyzed for each potential audience, using the modeled context, by matching content of the digital publication candidate to popular culture references and news information of the corresponding modeled context. Sentiment analysis is performed on the matched content to determine when the digital publication candidate represents a reputational risk to the user for at least one of the potential audiences. A segment of the digital publication candidate corresponding to the matched content is highlighted when it is determined that the reputational risk exists.

### BACKGROUND

The present invention relates to predicting reputational impact and, more specifically, to a system for predicting a reputational impact of digital publication in real-time.

Digital publication, as used herein, relates to the act of submitting media content such as text, audio, still photographs, and/or video to be made available for view either by the general public, or some subset thereof. This may include posting on social media, enterprise social networks, internet websites, corporate intranets and shared knowledgebases, feedback portals, internet forums, etc. Digital publications need not be made widely available. As used herein, a digital publication may include an electronic correspondence intended for one or several readers such as email, text messages and correspondences on other messaging/chat platforms, and the like.

Often, users may make such a digital publication without adequately understanding a reputational impact of the digital publication. While this may be due to the user's failure to adequately consider how the digital publication would be perceived by others, more often, the context of the digital publication is not entirely knowable to the user. For example, the user might not be aware of news stories that are breaking while the user is preparing the digital publication, and other times, the user is not fully aware of the context in which the digital publication is to be displayed, even though this context can affect the manner in which the digital publication is interpreted by others.

Additionally, the user may be geographically distant from at least part of the audience of the digital publication and/or there may be other barriers between the user and the audience, such as cultural barriers, language barriers, time zone barriers, all of these circumstances may limit the ability of the user to understand the manner in which the user's digital publications would be interpreted by the audience.

This gap between the understanding of the user generating digital publications and the audience interpreting it can lead to reputational risks to the user, as the digital publications are interpreted by the audience in a manner unforeseen by the user.

### SUMMARY

A computer-implemented method for reviewing digital publications includes receiving a digital publication candidate while it is being composed by a user. One or more potential audiences for the digital publication candidate are identified based on a manner in which the digital publication candidate is to be published. Information is received from a plurality of information sources including news feeds and social media content. A context is modeled for each of the one or more potential audiences based on the received information from the plurality of information sources. The digital publication candidate is analyzed, for each of the one or more potential audiences, using the corresponding modeled context, by matching content of the digital publication candidate to popular culture references and news information of the corresponding modeled context. Sentiment analysis is performed on the matched content of the digital publication candidate and the corresponding modeled context to determine when the digital publication candidate represents a reputational risk to the user for at least one of the one or more potential audiences. A segment of the digital publication candidate corresponding to the matched content is highlighted when it is determined that the reputational risk exists.

A system for reviewing digital publications includes a context builder/audience modeler, a cognitive social impact engine, and a display device. The context builder/audience modeler receives a digital publication candidate and information from a plurality of information sources including news feeds and social media content and modeling a context for each of one or more potential audiences of the digital publication candidate based on the received digital publication candidate and the received information from the plurality of information sources. The cognitive social impact engine analyzes the digital publication candidate, for each of the one or more potential audiences, using the corresponding modeled context, by matching content of the digital publication candidate to popular culture references and news information of the corresponding modeled context and determining when the digital publication candidate represents a reputational risk to the user for at least one of the one or more potential audiences, therefrom. The display device for displaying the digital publication candidate, as it is being composed by a user, and highlighting a segment of the digital publication candidate corresponding to the matched content when it is determined that the reputational risk exists.

A computer program product for reviewing digital publications includes a computer readable storage medium having program instructions embodied therewith. The program instructions are executable by a computer to cause the computer to receive a digital publication candidate, by the computer, while the digital publication candidate is being composed by a user. One or more potential audiences for the digital publication candidate are identified based on a manner in which the digital publication candidate is to be published. Information from a plurality of information sources including news feeds and social media content is received. A context for each of the one or more potential audiences is modeled based on the received information from the plurality of information sources. The digital publication candidate is analyzed, for each of the one or more potential audiences, using the corresponding modeled context, by matching content of the digital publication candidate to popular culture references and news information of the corresponding modeled context. Sentiment analysis is performed on the matched content of the digital publication candidate and the corresponding modeled context to determine when the digital publication candidate represents a reputational risk to the user for at least one of the one or more potential audiences. A segment of the digital publication candidate corresponding to the matched content is highlighted when it is determined that the reputational risk exists.

### BRIEF DESCRIPTION OF THE SEVERAL VIEWS OF THE DRAWINGS

A more complete appreciation of the present invention and many of the attendant aspects thereof will be readily obtained as the same becomes better understood by reference to the following detailed description when considered in connection with the accompanying drawings, wherein:

FIG. 1 is a schematic diagram illustrating a system for real-time prediction of reputational impact of a digital publication in accordance with exemplary embodiments of the present invention;

FIG. 2 is a flow chart illustrating an approach for real-time prediction of reputational impact of a digital publication that may utilize the system shown in FIG. 1, in accordance with exemplary embodiments of the present invention;

FIG. 3 is a schematic diagram illustrating a user interface for performing real-time prediction of reputational impact of a digital publication in accordance with exemplary embodiments of the present invention; and

FIG. 4 shows an example of a computer system capable of implementing the method and apparatus according to embodiments of the present disclosure.

### DETAILED DESCRIPTION

In describing exemplary embodiments of the present invention illustrated in the drawings, specific terminology is employed for sake of clarity. However, the present invention is not intended to be limited to the illustrations or any specific terminology, and it is to be understood that each element includes all equivalents.

Exemplary embodiments of the present invention provide systems for interpreting a digital publication of a user by one or more prospective audiences that takes into account contextual data that is occurring contemporaneously with the preparation of the digital publication so that the user may be made aware of potential reputational risks caused by the digital publication, for each of a plurality of audience groups.

This may be performed by receiving the candidate digital publication, either after it is constructed, or while it is being constructed. As the digital publication is being constructed and/or shortly thereafter, social media sources, news sources, are mined for relevant contextual information. Information obtained from these and other sources may be characterized according to audience groups, particularly those audience groups that the user's digital publication is likely to be consumed by. Then, for each audience group, contextual information is gleamed. Contextual information, as used herein, describes current events, cultural trends, internet memes, and other references of popular culture that are likely to affect the interpretation of the digital publication. Then, the digital publication is analyzed, for each audience group, based on the context data that is built for that particular audience group. The analysis may provide an indication as to whether the digital publication is likely to have a negative impression that may represent a reputational risk to the published, when read by members of each audience. The results of this analysis may then be presented to the user prior to publishing the digital publication so that reputational risk may be mitigated.

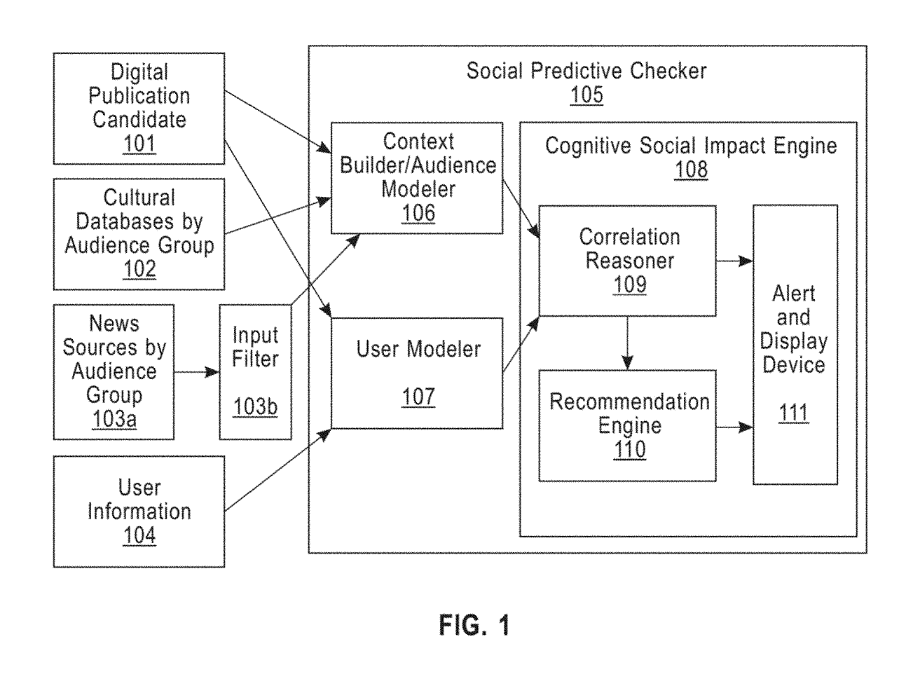

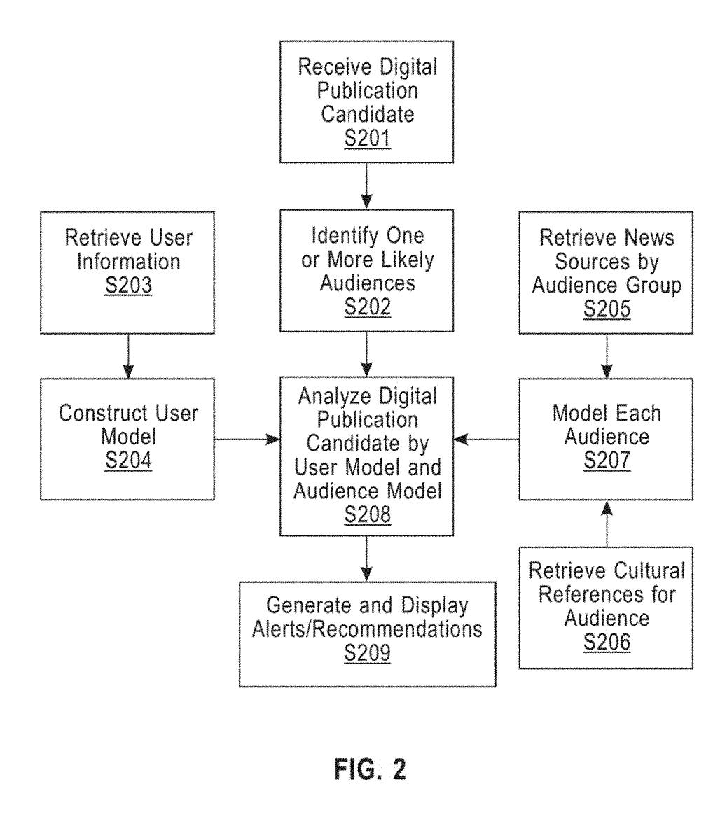

FIG. 1 is a schematic diagram illustrating a system for real-time prediction of reputational impact of a digital publication in accordance with exemplary embodiments of the present invention. FIG. 2 is a flow chart illustrating an approach for real-time prediction of reputational impact of a digital publication that may utilize the system shown in FIG. 1, in accordance with exemplary embodiments of the present invention.

Referring to FIGS. 1 and 2, first a user's digital publication candidate 101 may be received (Step S201). As mentioned above, the digital publication candidate 101 may include text, audio, still imagery, and/or video that the user intends to make public, such as a posting to a social media platform, or to otherwise make available to others, such as a private email, text message, etc. The digital publication candidate 101 need not be finalized and ready for publication. According to one exemplary embodiment of the present invention, the process described below may be performed in real-time, for example, as the user is writing the text, recording the audio, capturing/drawing/editing the image, or recording the video. The intended manner of publication may be known by the system. The intended manner of publication may include an indication as to when and where the digital publication candidate 101 is to be published and who the potential viewers may be. This information may be provided by the user, known from the application/website in which the user is using to construct the digital publication candidate 101, and/or determined by seeing who the user's social media connections are.

Using the intended manner of publication information, the system may determine one or more likely audience groups (Step S202). This step may be performed, for example, by a context builder/audience modeler 106. The context builder/audience modeler 106 may also retrieve/receive various news sources by audience group 103a (Step S205). For example, where the audience groups are populations by geographic regions, such as from a particular country, news feeds from that particular country may be retrieved/received. Various cultural references may be retrieved from a database of cultural information 102 (Step S206). From the various news sources 103a and cultural references 102, the context builder/audience modeler 106 may establish a model for each likely audience group (Step S207). Each audience model may be a collection of information that the potential audience is likely to know or is likely to be displayed in close proximity to the digital publication candidate 101 within the intended manner of publication. For example, if one of the potential audiences is a Chinese audience, the model for this audience may include knowledge of popular cultural references known to those in China, as well as current events of significance and/or timeliness that are likely to be on the minds of the Chinese audience. If another potential audience is a United States audience, the model for this audience may include corresponding information. However, audiences need not be designated exclusively by geography, audiences may be defined by cultures, languages, organizations, topics of interest, etc.

According to some exemplary embodiments of the present invention, as part of the step of retrieving the news sources by audience group (Step S205), the news sources 103a may be correlated with each other to identify recurrence of stories. Stories that are reported from a greater number of outlets may be regarded as more significant than stories that are reported from only a single news outlet. Correlation is not limited to news outlets, and social media posts regarding the topic by individuals on social media, either from the public at large or from the user's connections/friends/followers, etc., may be used as corroboration as well. In this way, a simple event may be elevated to the status of “major event” and according to some exemplary embodiments of the present invention, only major events, so categorized, may be used to construct the audience models. This correspondence of sources may be performed by an input filter/news filter 103b.

User information 104 may be retrieved by a user modeler 107 (Step S203). User information may include, for example, social media profile and other content of the user's, demographic information, location information, languages spoken, information pertaining to who has access to see the user's social media posts and other publications, etc.

The use modeler 107 may use the retrieved user information 104 to construct a model for the user (Step S204). A correlation reasoner 109 may take the audience models from the context builder/audience modeler 106 as well as the constructed user model from the user modeler 107 and use them to analyze the digital publication candidate 101 in the context of each potential audience (Step S208). In this step, correlations between the subject matter of the digital publication candidate and each context are made so that potentially relevant information may be surfaced from each audience model.

For example, where the digital publication candidate 101 is a joke or metaphor relating to drowning and one of the potential audiences is determined to be people in China, and where the news feeds from China report on recent catastrophic flooding, the system described herein could determine that people in China is one of the potential audiences and then analyze the news feeds from China to determine if there is subject matter similarities between the subject matter of the digital publication candidate 101 and that of the news feeds from the appropriate audience model. The analysis of the digital publication candidate 101 by the user model and audience model may include performing sentiment analysis on both the digital publication candidate 101 and the matched subject matter from the audience model so that it may be determined whether the digital publication candidate 101 relates to a message of sympathy/support, or some other positive sentiment, or whether the digital publication candidate 101 expresses a sentiment that would not be appropriate, or otherwise pose a reputational risk, in light of the audience model.

From this analysis, a recommendation concerning the digital publication candidate 101 may be made by a recommendation engine 110 (Step S209). The recommendation made may be to edit the digital publication candidate 101 to remove reference to a particular topic that closely matches the topic of the audience model. The recommendation may be in the form of an alert that may be displayed on a display device 111, for example, as will be described in greater detail below.

A user who is located in the United States, for example, may wish to make a social media post in a social network for which the user has contacts who reside in China. However, the user, living in the United States, may not be well informed about current events in China. The present approach may therefore analyze the user's social media post, before it is sent, and, for example, while it is being constructed, in light of an audience profile for each potential audience group that may have access to seeing the post. Current events and other cultural references may be surfaced where they correspond to subject matter of the post, and where the sentiment analysis indicates that the user's post may be interpreted by a particular audience group as inappropriate in light of certain events and/or cultural references and cultural sensitivities, the user may receive an alert, for example, in the form of a highlighting of the potentially problematic text or other media content.

It is not possible for a user to be aware of all cultural sensitivities, all current events in all geographic regions, etc. and accordingly, exemplary embodiments of the present invention may be used to give the user useful insight into these domains. Further, while some audiences may include many millions of people, an audience, as used herein, may include as few as a single person who may potentially see the publication, but for whom certain topics may represent traumatic triggers or other potential sources of negative emotional responses. In this way, on a social network, each of the user's contacts/friends/followers, etc. may constitute an audience and each of these people's own social media profiles, posts, mentions, etc. may be crawled to determine sensitivities so that if the subject matter of the digital publication candidate 101 correlates with the individual sensitivities of a single-person audience, then the user may be generated prior to the publishing.

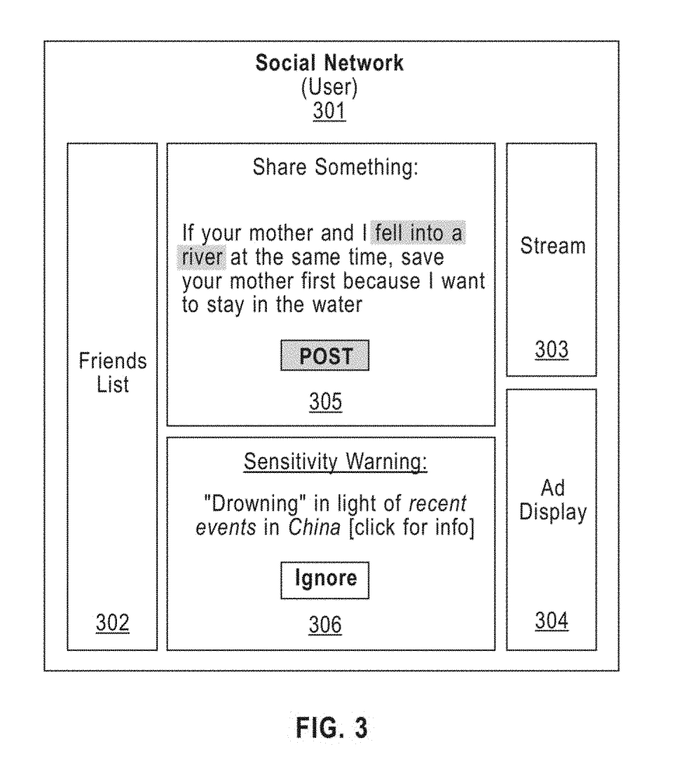

FIG. 3 is a schematic diagram illustrating a user interface for performing real-time prediction of reputational impact of a digital publication in accordance with exemplary embodiments of the present invention. As can be seen, the user may interact with a social network interface screen 301 which may be a mobile user interface (UI) or a desktop UI, for example, a website rendered by a web browser. The social network UI 301 may include a list of contacts/friends/followers etc. 302, a stream/feed of content displayed to the user 303, advertisements 304, and a UI element in which the user may prepare and post a digital publication 305.

As the user is preparing the digital publication, the above-described system may perform the above-described analysis. While the user is constructing the digital publication, for example, by typing, recording, uploading, etc., the content of the digital publication may be analyzed as it is provided. Content that is analyzed to be a potential reputational risk may be highlighted or otherwise emphasized, for example, within the UI element in which the user may prepare and post a digital publication 305. Additionally, a UI element for posting/publishing the digital publication may be “greyed out” i.e. deactivated, unless and until the user either remove the problematic subject matter or affirmatively select to ignore the problem.

In the example illustrated in FIG. 3, the user has entered the text, “If your mother and me fell into a river at the same time, save your mother first because I want to stay in the water.” The user has not yet completed the posting, however, the phrase “fell into a river” is highlighted as the user continues to type. The user may have intended the comment to relate to a heatwave that the user is experiencing, and a desire to go for a swim, however, unknown to the user, current events in a different part of the country involve catastrophic flooding. As many of the user's contacts who would see the digital publication may live in the area experiencing the flooding, the digital publication may pose a reputational risk to the user, who may be seen as insensitive to current events the user may have known nothing about. This may be particularly relevant where news of the flooding did not break until after the user had begun to construct the digital publication candidate. As the user is engaged in the construction of the digital publication candidate, the user would not have the ability to take these events into consideration, however, as the digital publication candidate may be seen by many people at a later time, and it is likely that the digital publication candidate may be displayed to the user's contacts alongside the news reports of the flooding, the reputational risks to the user still exist. Accordingly, exemplary embodiments of the present invention are able to check the digital publication candidate for these reputational risks using news and other information that is obtained either right before the user begins to construct the digital publication candidate, while the user is constructing the digital publication candidate, and even after the user has constructed the digital publication candidate but before the digital publication candidate is published.

An alert window 306 may present to the user a short explanation as to the nature of the problem, with a link to see a more in depth explanation, which may, for example, point out to the user the particular audience affected and news articles that recount the events leading to the sensitivity.

Moreover, as described above, the context in which the digital publication candidate is to be presented to the audiences is considered. This may take into account advertisements 304 that are to be displayed in the social media stream 303 of the audience members so that any potential reputational risk associated with the way in which a digital publication candidate may be considered next to a particular advertisement may be considered. Additionally, this approach may be used to prevent a situation in which the usefulness of the advertisement display 304 may be undermined in light of the subject matter of the post 305.

To perform this step, an advertisement placement server may be contacted to determine advertisements that are to be displayed to each of the contacts/friends/followers, etc. of the user alongside, or in close spatial or temporal proximity to the display of the particular digital publication candidate.

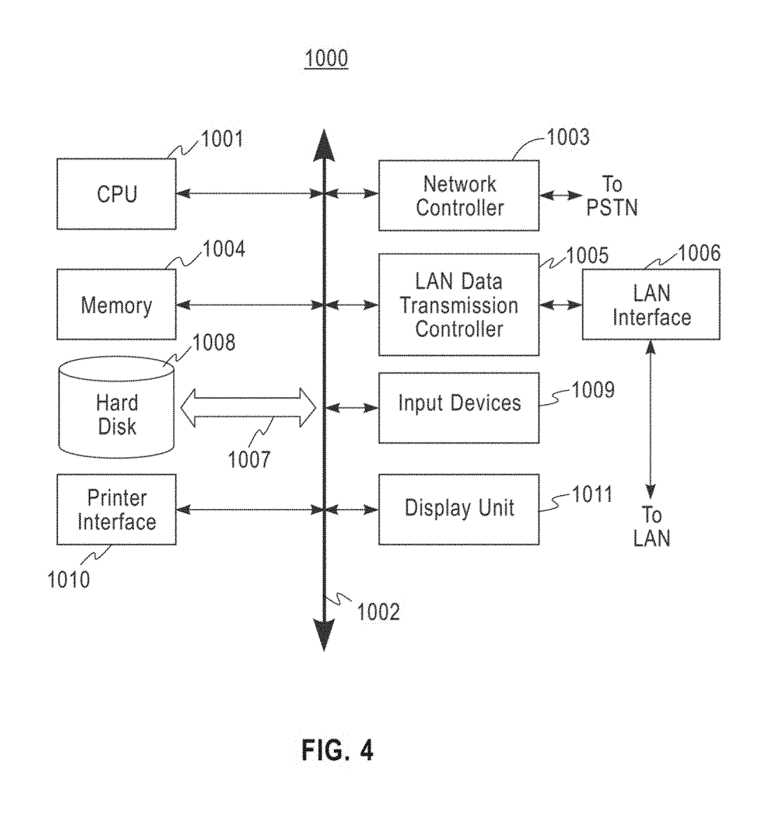

FIG. 4 shows another example of a system in accordance with some embodiments of the present invention. By way of overview, some embodiments of the present invention may be implemented in the form of a software application running on one or more (e.g., a “cloud” of) computer system(s), for example, mainframe(s), personal computer(s) (PC), handheld computer(s), client(s), server(s), peer-devices, etc. The software application may be implemented as computer readable/executable instructions stored on a computer readable storage media (discussed in more detail below) that is locally accessible by the computer system and/or remotely accessible via a hard wired or wireless connection to a network, for example, a local area network, or the Internet.

Referring now to FIG. 4, a computer system (referred to generally as system 1000) may include, for example, a processor e.g., central processing unit (CPU) 1001, memory 1004 such as a random access memory (RAM), a printer interface 1010, a display unit 1011, a local area network (LAN) data transmission controller 1005, which is operably coupled to a LAN interface 1006 which can be further coupled to a LAN, a network controller 1003 that may provide for communication with a Public Switched Telephone Network (PSTN), one or more input devices 1009, for example, a keyboard, mouse etc., and a bus 1002 for operably connecting various subsystems/components. As shown, the system 1000 may also be connected via a link 1007 to a non-volatile data store, for example, hard disk, 1008.

In some embodiments, a software application is stored in memory 1004 that when executed by CPU 1001, causes the system to perform a computer-implemented method in accordance with some embodiments of the present invention, e.g., one or more features of the methods, described with reference to FIGS. 1 and 2.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Exemplary embodiments described herein are illustrative, and many variations can be introduced without departing from the spirit of the invention or from the scope of the appended claims. For example, elements and/or features of different exemplary embodiments may be combined with each other and/or substituted for each other within the scope of this invention and appended claims.

What is claimed is:

1. A computer-implemented method for reviewing digital publications, comprising:
receiving a digital publication candidate while it is being composed by a user;
identifying one or more potential audiences for the digital publication candidate based on a manner in which the digital publication candidate is to be published;
receiving information from a plurality of information sources including news feeds and social media content;
modeling a context for each of the one or more potential audiences based on the received information from the plurality of information sources;
analyzing the digital publication candidate, for each of the one or more potential audiences, using the corresponding modeled context, by matching content of the digital publication candidate to popular culture references and news information of the corresponding modeled context;
performing sentiment analysis on the matched content of the digital publication candidate and the corresponding modeled context to determine when the digital publication candidate represents a reputational risk to the user for at least one of the one or more potential audiences; and
highlighting a segment of the digital publication candidate corresponding to the matched content when it is determined that the reputational risk exists.

2. The computer-implemented method of claim 1, further including preventing the publication of the digital publication candidate by the manner in which the digital publication candidate is to be published, when it is determined that the reputational risk exists until the user either removes the highlighted segment or affirmatively overrides the preventing.

3. The computer-implemented method of claim 1, wherein the highlighting of the segment of the digital publication candidate corresponding to the matched content is performed prior to the completion of the composition of the digital publication candidate.

4. The computer-implemented method of claim 1, wherein the information is received from the plurality of information sources while the digital publication candidate is being composed.

5. The computer-implemented method of claim 1, further comprising:
receiving information pertaining to the user;
constructing a user model based on the received information pertaining to the user; and
using the constructed user model in the analyzing of the digital publication candidate.

6. The computer-implemented method of claim 5, wherein the received information pertaining to the user includes a list of contacts, friends, or followers of the user.

7. The computer-implemented method of claim 1, wherein the information received from the news feeds is only incorporated into the modeling of the context for each of the one or more potential audiences when the information received from the news feeds is identified within at least a predetermined number of distinct news sources.

8. The computer-implemented method of claim 1, wherein the modeled context for each of the one or more potential audiences includes information indicating what content is likely to be displayed proximately to the digital publication candidate in the manner in which the digital publication candidate is to be published.

9. The computer-implemented method of claim 8, wherein the content likely to be displayed proximately to the digital publication candidate in the manner in which the digital publication candidate is to be published includes one or more advertisements.

10. A system for reviewing digital publications, comprising:
a context builder/audience modeler for receiving a digital publication candidate and information from a plurality of information sources including news feeds and social media content and modeling a context for each of one or more potential audiences of the digital publication candidate based on the received digital publication candidate and the received information from the plurality of information sources;
a cognitive social impact engine for analyzing the digital publication candidate, for each of the one or more potential audiences, using the corresponding modeled context, by matching content of the digital publication candidate to popular culture references and news information of the corresponding modeled context and determining when the digital publication candidate represents a reputational risk to the user for at least one of the one or more potential audiences, therefrom; and
a display device for displaying the digital publication candidate, as it is being composed by a user, and highlighting a segment of the digital publication candidate corresponding to the matched content when it is determined that the reputational risk exists.

11. The system of claim 10, further comprising a user modeler for constructing a user model based on information pertaining to the user, wherein the cognitive social impact engine is configured to use the constructed user model to analyze the digital publication candidate.

12. A computer program product for reviewing digital publications, the computer program product comprising a computer readable storage medium having program instructions embodied therewith, the program instructions executable by a computer to cause the computer to:
receiving a digital publication candidate, by the computer, while the digital publication candidate is being composed by a user;
identifying, by the computer, one or more potential audiences for the digital publication candidate based on a manner in which the digital publication candidate is to be published;
receiving, by the computer, information from a plurality of information sources including news feeds and social media content;
modeling, by the computer, a context for each of the one or more potential audiences based on the received information from the plurality of information sources;
analyzing, by the computer, the digital publication candidate, for each of the one or more potential audiences, using the corresponding modeled context, by matching content of the digital publication candidate to popular culture references and news information of the corresponding modeled context;
performing, by the computer, sentiment analysis on the matched content of the digital publication candidate and the corresponding modeled context to determine when the digital publication candidate represents a reputational risk to the user for at least one of the one or more potential audiences; and
highlighting, by the computer, a segment of the digital publication candidate corresponding to the matched content when it is determined that the reputational risk exists.

13. The computer program product of claim 12, wherein the program instructions executable by a computer to further cause the computer to prevent the publication of the digital publication candidate by the manner in which the digital publication candidate is to be published, when it is determined that the reputational risk exists until the user either removes the highlighted segment or affirmatively overrides the preventing.

14. The computer program product of claim of claim 12, wherein the highlighting of the segment of the digital publication candidate corresponding to the matched content is performed prior to the completion of the composition of the digital publication candidate.

15. The computer program product of claim of claim 12, wherein the information is received from the plurality of information sources while the digital publication candidate is being composed.

16. The computer program product of claim of claim 12, further comprising:
receiving information pertaining to the user;
constructing a user model based on the received information pertaining to the user; and
using the constructed user model in the analyzing of the digital publication candidate.

17. The computer program product of claim of claim 16, wherein the received information pertaining to the user includes a list of contacts, friends, or followers of the user.

18. The computer program product of claim of claim 12, wherein the information received from the news feeds is only incorporated into the modeling of the context for each of the one or more potential audiences when the information received from the news feeds is identified within at least a predetermined number of distinct news sources.

19. The computer-implemented method of claim 12, wherein the modeled context for each of the one or more potential audiences includes information indicating what content is likely to be displayed proximately to the digital publication candidate in the manner in which the digital publication candidate is to be published.

20. The computer-implemented method of claim 19, wherein the content likely to be displayed proximately to the digital publication candidate in the manner in which the digital publication candidate is to be published includes one or more advertisements.
